(19) United States
(12) Patent Application Publication
(10) Pub. No.: US 2003/0002857 A1
(43) Pub. Date: Jan. 2, 2003

(54) Electronic write protect detection for video tape recorders

(76) Inventor: Steven D. Curtin, Freehold, NJ (US)

Correspondence Address: Farkas & Manelli pllc, 7th Floor, 2000 M Street, N.W., Washington, DC, 20036-3307, US

(21) Appl. No.: 09/747,937

(22) Filed: Dec. 27, 2000

(51) Int. Cl. H04N 5/92

(52) U.S. Cl. 386/94; 360/60

(57) ABSTRACT

An electronic video write protect system and method comprising the use of a rotating video head that contains both a conventional record/play element and a pre-existing video signal detection element. A pre-existing video signal line runs from the pre-existing signal detection element to record circuitry. From the record circuitry, a record signal line runs to the un-conventional rotating video head. A video tape passes across the rotating video head before the video head used for recording video information on the video tape, to receive/transfer information to a video recording device. If a pre-existing video signal is detected on the video tape, the record circuitry is disabled, thus preventing accidental overwrite of pre-existing video information on that portion of the video tape. However, recording is allowed on the portions of the video tape which do not contain pre-existing video content.

### BACKGROUND OF THE INVENTION

1. Field of the Invention

This invention relates generally to protecting information previously recorded on magnetic media from being overwritten. More particularly, it relates to a system and method for protecting information previously recorded on a video tape through a signal detection element to determine if pre-existing information exists on the video tape.

2. Background of Related Art

Write protect schemes for magnetic media come in two varieties, electronic coding to prevent erasure and electro-mechanical using a physically removable write protect tab.

An example of electronic coding to prevent erasure is a computer's magnetic media such as the widely popular Zip disk technology. Information is stored on a Zip disk through a conventional read/write head similar to a conventional floppy disk. To protect the data from being overwritten by new data, Zip technology codes the data as being only available for read purposes. Since the data can't be written to, the data can't be accidentally erased by a computer's operating system. The data can be made erasable by a user if desired, simply by changing the file properties.

An example of an electro-mechanical system for write protection is a video tape recorder. Video tape recorders have come into wide use within recent years. Price reductions in video tape recorders, video cameras and video cassettes have led consumers to purchase multiple units within a single household. Libraries of video tapes used in video tape recorders and video cameras number into the hundreds in many households.

Video tape libraries frequently contain video information that users do not want to lose by accidental overwriting. Video tape libraries frequently contain such video information as weddings, child birth, favorite movies, collections of episodes of a favorite television program, etc.

FIG. 6 illustrates a conventional video cassette containing video tape 6 used to record video information. Conventional video cassettes have a write protect tab 2 that is used to prevent the video tape 6 from being written to once removed. The write protect tab is physically removed from the video cassette housing 1 by simply bending the write protect tab 2 away from the video cassette housing 1. An electrical sensor inside the video recorder senses that the plastic tab is missing from the video cassette housing 1, and sends a signal to the video tape recording mechanism to prevent further recording onto the video tape 6.

The write protect tab 2 is normally constructed of plastic that will easily break away from the video cassette housing 1. Once the write protect tab is removed, the entire video tape 6 can't be written to again, thus preventing overwrite of existing video information with new video information.

There are disadvantages to removing a write protect tab 2 to write protect the video tape 6 within a video cassette. For instance, once the write protect tab 6 is removed, the entire video tape 6 can not be recorded to again, even if most of the video tape 6 is unused.

Also, if a user decides to record over existing video information once the write protect tab 6 is removed, adhesive tape or other article must be used to fill the space which was originally occupied by the write protect tab 6. Adhesive tape or other article on the video tape housing 1 introduces the possibility of a foreign object falling into the video tape recorder mechanism, possible causing damage which might require servicing by a technician.

FIG. 5 illustrates a conventional video tape recording mechanism utilizing a record/play element 3 mounted on the rotating video head 8 to both record and play video information. From the record circuitry 10, a record signal line 11 runs to the conventional rotating video head 8. A video tape 6 passes across the conventional rotating video head 8 to receive or transfer information from or to a video recording device.

In operation, a rotating head 8 spins at a high speed to pass the attached record/play element 3 past the video tape 6. The video tape also is moving, traveling past the rotating video head 8 to the left as indicated. As the record/play element 3 sweeps past the video tape 6, information is either written to or read from the video tape 6, depending on the video recorder mode selected by a user. A single record/play element 3 is shown for ease of understanding, with multiple record/play elements commonly used to increase the quality of the picture either read from or written to the video tape 6.

There exists a need for an apparatus and method that does not rely on a write protect tab to detect if a video tape contains pre-existing video information, or to otherwise prevent overwriting of the video information.

### SUMMARY OF THE INVENTION

In accordance with the principles of the present invention, a video write protect system comprises an un-conventional rotating video head contains both a conventional record/play element and a novel pre-existing signal detection element. A pre-existing signal line runs from pre-existing signal detection element to record circuitry. From the record circuitry, a record signal line runs to the un-conventional rotating video head. A video tape passes across the un-conventional rotating video head to receive/transfer information to a video recording device.

A video write protect system in accordance with another aspect of the present invention comprises a conventional rotating video head having a conventional record/play element. A stationary pre-existing signal detection element is placed in the video tape path prior to the conventional rotating video head. A pre-existing signal line runs from the stationary pre-existing signal detection element to record circuitry. From the record circuitry, a record signal line runs to the conventional rotating video head. A video tape passes across the conventional rotating video head to receive/transfer information to a video recording device.

A video write protect system in accordance with yet another aspect of the present invention comprises an un-conventional video head containing a conventional first record/play element and a novel second record/play element. A pre-existing signal line runs to record circuitry. From the record circuitry, a record signal line runs to the conventional rotating video head. A video tape passes across the conventional rotating video head to receive/transfer information to a video recording device.

### BRIEF DESCRIPTION OF THE DRAWINGS

Features and advantages of the present invention will become apparent to those skilled in the art from the following description with reference to the drawings, in which:

FIG. 1 shows a video tape recording system utilizing a pre-existing detection element on the rotating video head, in accordance with the principles of the present invention.

FIG. 2 shows another embodiment of a video tape recording system utilizing a stationary signal detection head, in accordance with the principles of the present invention, in accordance with the principles of the present invention.

FIG. 3 shows yet another embodiment of a video tape recording system utilizing a second play/record element as the pre-existing video detection element, in accordance with the principles of the present invention.

FIG. 4 is a flow chart illustrating an exemplary process by which a video tape recording system preserves pre-existing video tape information, in accordance with the principles of the present invention.

FIG. 5 shows a prior art video tape recording mechanism.

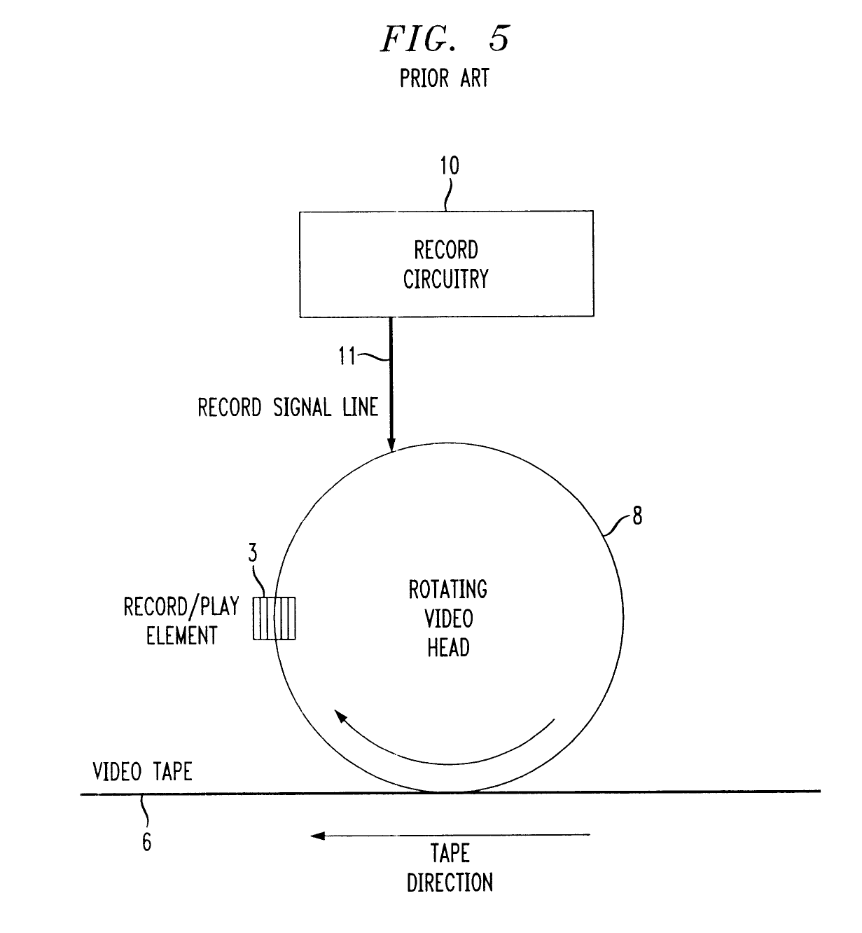

FIG. 6 shows a conventional video cassette having a write protect tab.

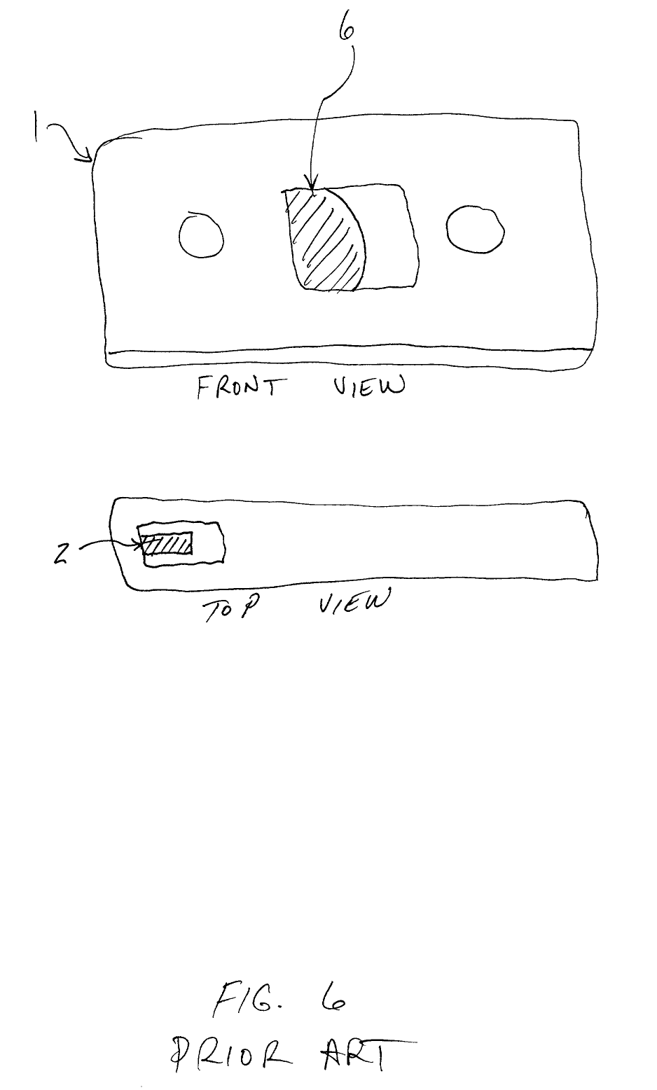

### DETAILED DESCRIPTION OF ILLUSTRATIVE EMBODIMENTS

The present invention provides a method and apparatus for preventing pre-existing video tape information on a video tape cassette from being erroneously replaced by newly recorded video tape information. In accordance with the principles of the present invention, a pre-existing signal detection element is used to determine if the video tape contains video information at the time the user desires to record new video information to the video tape.

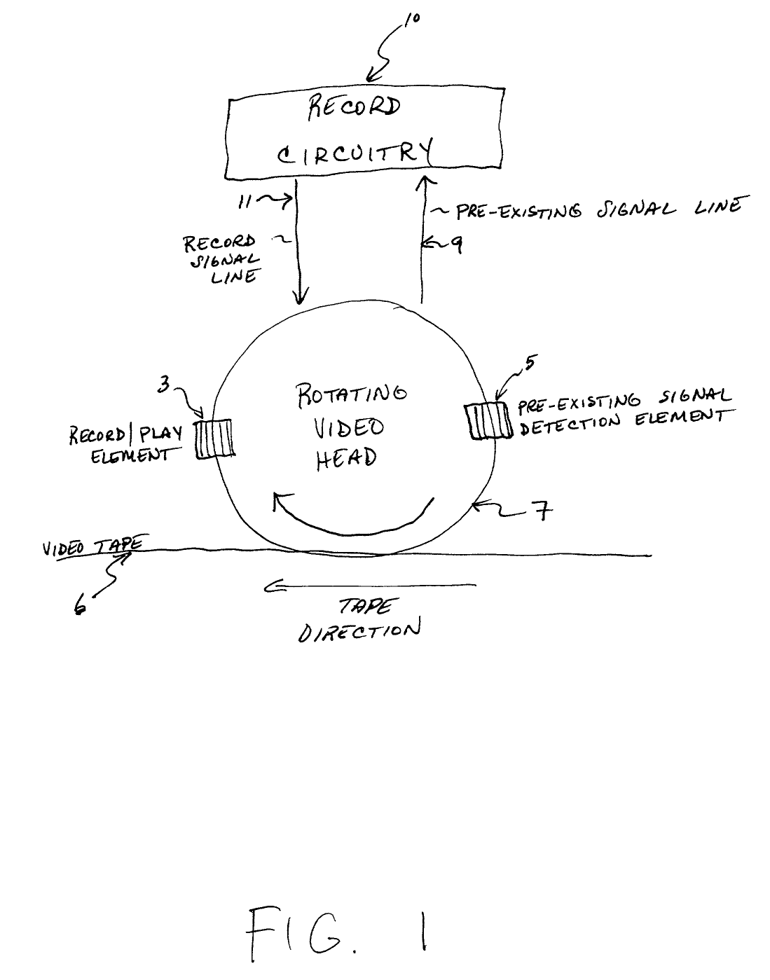

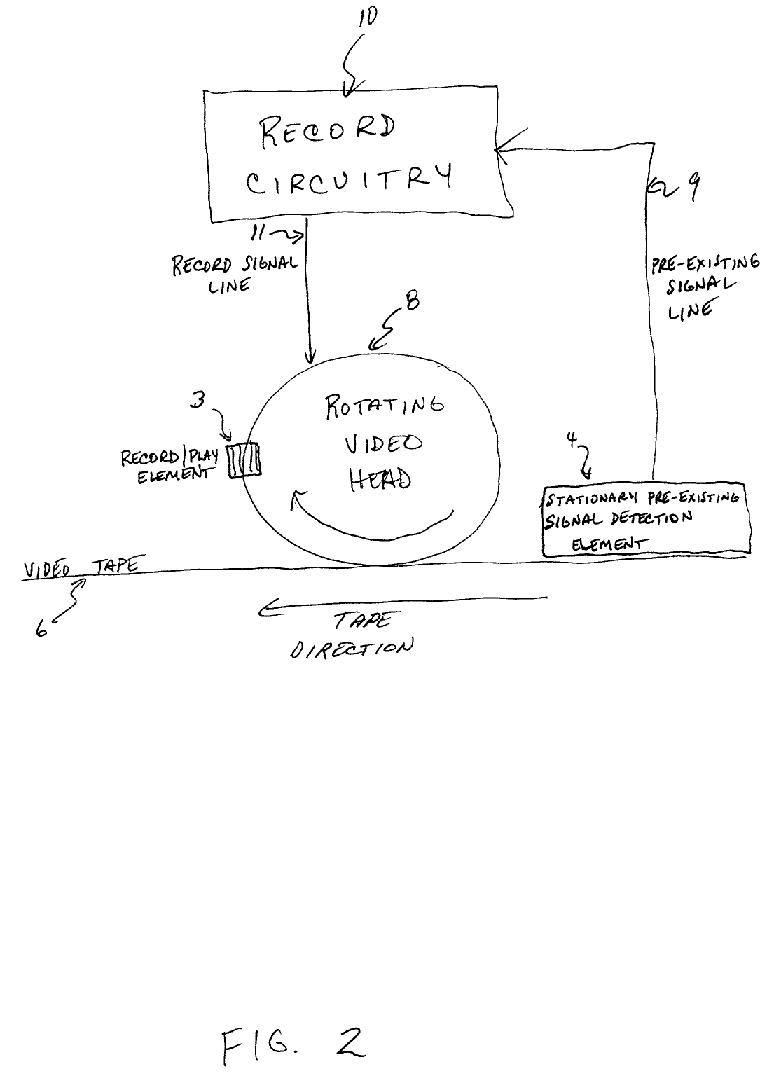

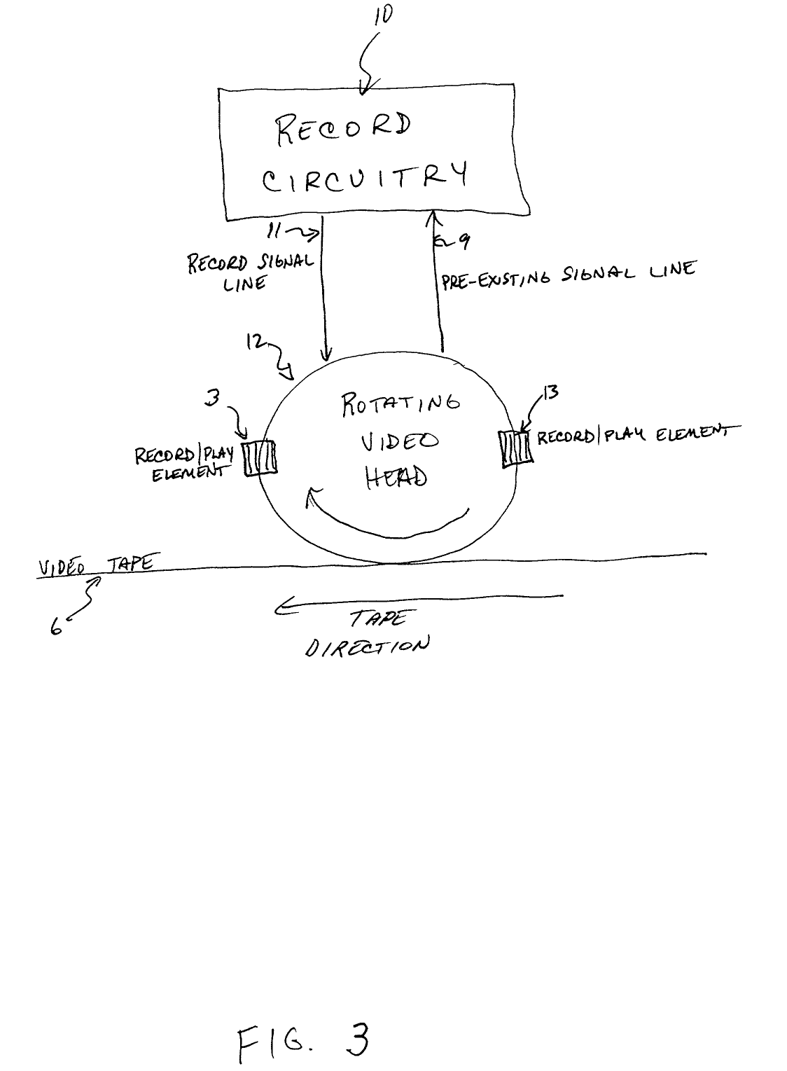

FIG. 1 shows a first embodiment in accordance with the principles of the present invention utilizing a pre-existing signal detection element mounted on a rotating video head to determine if a video tape cassette 6 contains pre-existing information. FIG. 2 shows a second embodiment in accordance with the principles of the present invention utilizing a stationary pre-existing signal detection element to determine if a video tape cassette contains pre-existing information. FIG. 3 show a third embodiment in accordance with the principles of the present invention utilizing a record/play element as a pre-existing signal detection element to determine if a video tape cassette contains pre-existing information.

In particular, FIG. 1 shows an un-conventional rotating video head 7 containing both a conventional record/play element 3 and a novel pre-existing signal detection element 5. A pre-existing signal line 9 runs from pre-existing signal detection element 5 to record circuitry 10. From the record circuitry 10, a record signal line 11 runs to the un-conventional rotating video head 7. A video tape 6 passes across the un-conventional rotating video head 7 to receive/transfer information to a video recording device.

In operation, the rotating video head 7 spins clockwise in the direction indicated. The record/play element 3 and the pre-existing signal detection element 5 sweep past the moving video tape 6 to detect or record information thereon.

The pre-existing signal detection element 5 sweeps past the video tape 6 prior to the record/play element 3. In this manner, the pre-existing signal detection element 5 is able to determine if video tape 6 of the relevant video tape cassette contains pre-existing video information prior to record/play element 3 reaching the video tape 6. If pre-existing video information is detected by pre-existing signal detection element 5, then a pre-existing signal is sent to record circuitry 10 on the pre-existing signal line 9.

Once the record circuitry 10 receives a pre-existing signal from pre-existing signal detection element 5, the record circuitry 10 becomes disabled. Disabling record circuitry 10 will prevent any new video information from being passed along the record signal line 11 to the record/play element 3. Since no new video information is passed to record/play element 3, the pre-existing video information on video tape 6 is preserved.

FIG. 2 shows a conventional rotating video head 8 having a conventional record/play element 3. However, instead of having the novel pre-existing signal detection element 5 attached to the rotating video head 7 as shown in FIG. 1, a stationary pre-existing signal detection element 4 is employed. A pre-existing signal line 9 runs from the stationary pre-existing signal detection element 4 to the record circuitry 10. From the record circuitry 10, a record signal line 11 runs to the conventional rotating video head 8. A video tape 6 passes across the conventional rotating video head 8 to receive/transfer information to a video recording device.

In operation, the stationary pre-existing signal detection element 4 is arranged in the video tape 6 path prior to the video tape 6 arriving at the conventional rotating video head 8. The stationary pre-existing signal detection element 4 detects the presence of pre-existing video information on the video tape 6, and sends a pre-existing video signal on the pre-existing signal line 9 to the record circuitry 10.

Once the record circuitry 10 receives a pre-existing signal from the pre-existing signal detection element 5, the record circuitry 10 will become disabled. For example, in the exemplary embodiment, the disabling record circuitry 10 will prevent any new video information from being passed along the record signal line 11 to the record/play element 3. Thus, since no new video information is passed to record/play element 3, the pre-existing video information on the video tape 6 is preserved.

FIG. 3 shows an un-conventional video head 12 containing a conventional first record/play element 3 and a novel second record/play element 13. A pre-existing signal line 9 runs to record circuitry 10 from the second record/play element 13. From the record circuitry 10, a record signal line 11 runs to the un-conventional rotating video head 12. A video tape 6 passes across the rotating un-conventional video head 8 to receive/transfer information to a video recording device.

In operation, the un-conventional rotating video head 12 spins clockwise in the direction indicated. The first record/play element 3 and the novel second record/play element 13 sweeps past the moving video tape 6 to detect or record information thereon.

The second record/play element 13 preferably sweeps past the video tape 6 prior to the first record/play element 3. In this manner, the second record/play element 13 is able to determine if the video tape 6 contains pre-existing video information prior to the same point on the video tape 6 reaching the first record/play element 3. If pre-existing video information is detected by the second record/play element 13, a pre-existing information signal is sent to the record circuitry 10, e.g., on the pre-existing signal line 9.

Once the record circuitry 10 receives a pre-existing information signal from the second record/play element 13, the record circuitry 10 will become disabled. Disabling record circuitry 10 may be implemented to prevent any new video information from being passed along the record signal line 11 to either the first record/play element 3 or the second record/play element 13. Since no new video information is passed to either the first record/play element 3 or the second record/play element 13, the pre-existing video information on video tape 6 is preserved.

One advantage of using two record/play elements, 3 and 13, on the video head 12 is that both video heads 3 and 13 may be used to record video information to the video tape 6 in applications where a user is unconcerned about preserving pre-existing video information. Moreover, the use of two record/play elements allow the video head 12 to record a higher quality video signal on the video tape 6 when the first and second record/play elements, 3 and 13 are both used to record information on the video tape 6.

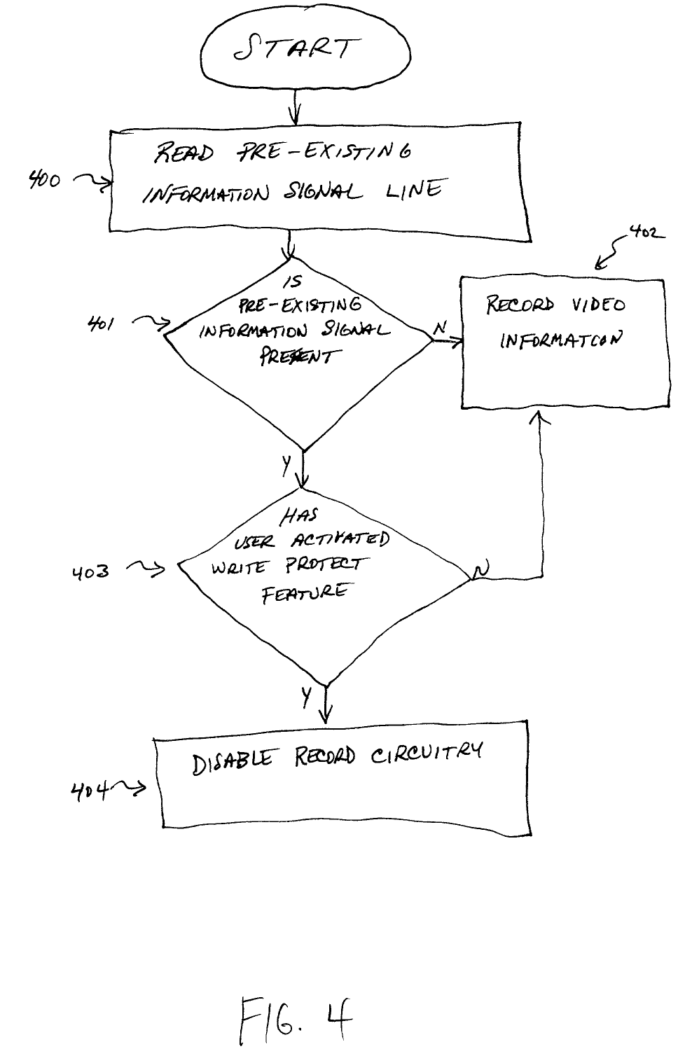

FIG. 4 is a flow chart showing an exemplary process by which a pre-existing signal detection element may be used to determine if pre-existing video information exists on video tape 6.

With reference to FIGS. 1, 2, and 3, in the first step 400 of FIG. 4, pre-existing information signal line 9 is read by record circuitry 10.

In step 401, a decision is made if pre-existing information is present.

If no pre-existing information is present, record circuitry 10 is permitted to record video information on video tape 6 at step 402.

However, if pre-existing information is present, step 403 makes a determination if a user has activated the pre-existing information electronic detection write protect feature of the present invention.

If a user has not activated the electronic detection write protect feature of the relevant tape player, as determined in step 403, then record circuitry 10 is permitted to record video information on video tape 6 at step 402 (unless the physical tab is removed in an otherwise conventional write protect technique).

If a user has activated the physical write protect feature of the present invention, as determined in step 403, step 404 disables record circuitry 10.

With all of the disclosed embodiments herein, a user of the electronic write protection system and method disclosed herein would have the option to activate or deactivate the electronic write protect system based on a desire to prevent accidental overwrite of previously stored information.

Although the present invention is described with reference to embodiments preserving pre-existing video information on a video tape, the principles of the present invention are equally applicable to recording of other types of information, e.g, audio, data, multi-media etc.

Although the present invention is described with reference to embodiments using a single element for play/record operations and another single element to detect pre-existing video information, those skilled in the art would be able to recognize the benefits of using multiple play/record elements in conjunction with one or more pre-existing signal detection elements.

While the invention has been described with reference to the exemplary embodiments thereof, those skilled in the art will be able to make various modifications to the described embodiments of the invention without departing from the true spirit and scope of the invention.

What is claimed is:

1. An electronic write protect apparatus for storage media comprising:
at least one record/play element for reading and writing information to/from said storage media;
a pre-existing electronic information signal detection element to read information from said storage media;
a record circuit to activate and deactivate said at least one record/play element based on a state of a signal from said pre-existing information signal detection element.

2. The electronic write protect apparatus for storage media according to claim 1, comprising:
a plurality of record/play elements.

3. The electronic write protect apparatus for storage media according to claim 1, wherein:
said at least one record/play element is attached to a spinning element.

4. The electronic write protect apparatus for storage media according to claim 1, wherein:
said at least one record/play element is stationary.

5. The electronic write protect apparatus for storage media according to claim 3, wherein:
said pre-existing electronic signal detection element is attached to said spinning element.

6. The electronic write protect apparatus for storage media according to claim 1, wherein:
said storage media is a video tape.

7. The electronic write protect apparatus for storage media according to claim 1, wherein:
said storage media stores digital information.

8. The electronic write protect apparatus for storage media according to claim 1, wherein:
said pre-existing electronic signal detection element is a record/play element.

9. An electronic write protect method for a video cassette player comprising:
attempting to record information on a video tape;
detecting a pre-existing video signal from said video tape; and
deactivating a record circuit in said video cassette player based on said pre-existing video signal.

10. The electronic write protect method for storage media according to claim 9, wherein:
said step of attempting to record information is performed by multiple record/play elements.

11. The electronic write protect method for storage media according to claim 9, wherein:
said step of attempting to record information is performed by a spinning element.

12. The electronic write protect method for storage media according to claim 9, wherein:
said step of attempting to record information is performed by a stationary element.

13. The electronic write protect method for storage media according to claim 11, wherein:
said step of detecting a pre-existing video signal is performed by said spinning element.

14. The electronic write protect method for storage media according to claim 9, wherein:
said video tape stores digital information.

15. The electronic write protect method for storage media according to claim 9, wherein:
said step of detecting a pre-existing video signal is performed by a record/play element.

16. An electronic write protect means for a video cassette player comprising:
means for attempting to record information on a video tape;
means for detecting a pre-existing video signal from said video tape; and
means for deactivating a record circuit in said video cassette player based on said pre-existing video signal.
